(19) United States
(12) Patent Application Publication
(10) Pub. No.: US 2019/0069583 A1
(43) Pub. Date: Mar. 7, 2019

(54) LIQUID PLANT-BASED CREAMERS WITH NATURAL HYDROCOLLOIDS

(71) Applicant: NESTEC S.A., Vevey (CH)

(72) Inventors: Matthew Galen Bunce, Glen Burnie, MD (US); Jun-Tse Ray Fu, Dublin, OH (US); Maxime Saffon, Dublin, OH (US); Alexander A. Sher, Dublin, OH (US); Winnie Octavia, Delaware, OH (US)

(21) Appl. No.: 16/086,387

(22) PCT Filed: Mar. 22, 2017
(86) PCT No.: PCT/EP2017/056771

§ 371 Date: Sep. 19, 2018

Related U.S. Application Data
(60) Provisional application No. 62/311,817, filed on Mar. 22, 2016.

(51) Int. Cl. A23L 9/20; A23L 25/00; A23L 29/25; A23L 29/269; A23L 2/60; A23L 3/16

(52) U.S. Cl. CPC A23L 9/24; A23L 25/30; A23L 29/25; A23V 2002/00; A23L 2/60; A23L 3/16; A23L 29/272

(57) ABSTRACT

The present invention relates to beverage products, in particular a liquid natural plant-based creamer composition comprising: an edible nut; high-acyl gellan gum present in an amount ranging from 0.07 to 0.15 wt/wt %; acacia senegal gum present in an amount ranging from 0.30 to 1.50 wt/wt %; and buffer ranging from 0.1 to 0.4 wt/wt %.

### FIELD OF THE INVENTION

The present invention relates to liquid creamers and the method to produce the same. More specifically, the present disclosure is directed to creamers with natural hydrocolloids. Such creamer provides indulgent texture and mouthfeel when added to beverages such coffee or tea.

### BACKGROUND OF THE INVENTION

Creamers are widely used as whitening agents with hot and cold beverages such as, for example, coffee, cocoa, tea, etc. They are commonly used in place of milk and/or dairy cream.

Recent trends indicate that more and more consumers are seeking for dairy alternatives. For example, consumers consider plant-based creamers to whiten their cup. One drawback to consider while developing such creamers is that plant proteins often tend to give an off-flavor to the final beverage constituting the creamer.

Creamers may come in a variety of different flavors and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel. Mouthfeel, also denoted richness, texture or creaminess, is usually provided by the oil emulsion present in the creamer.

Thus, it is critical not only to enhance texture/mouthfeel of coffee with creamers but also to have stable liquid coffee creamers as is without compromising creamer stability over shelf life (at least 5 months at refrigeration and ambient temperatures for aseptic products).

All previous attempts to increase texture/mouthfeel of liquid creamers had the following drawbacks:
High viscosity of liquid creamers resulting in poor pour-ability from the bottle;
Dripping-back liquid stream during pouring; and
Phase separation (gelation, serum formation) during shelf life

The present invention allows to solve the following problems:
poor emulsion stability of the Extended Shelf Life (ESL) creamers over shelf life (5 months, refrigeration); and
poor sensory characteristics of plant-based creamers (e.g. smoothness, body, bitterness, oxidized flavors).

Other solutions to stabilize emulsion in liquid creamers are to use sodium caseinate which is not plant based and hence cannot be considered as a natural ingredient. Similarly, mono or di glycerides as well as DATEM (diacetyl tartaric acid ester of mono- and diglycerides) are synthetic and are not considered as natural ingredients.

Thus, there are no solutions available for natural, stable liquid plant-based creamer.

The present invention relates to non-dairy ESL aseptically packaged liquid creamers comprising natural stabilizing systems, and to the process of making thereof.

### SUMMARY OF THE INVENTION

In one aspect, the present invention relates to a liquid natural plant-based creamer composition comprising: an edible nut; high-acyl gellan gum present in an amount ranging from 0.07 to 0.15 wt/wt %; acacia senegal gum present in an amount ranging from 0.3 to 1.5 wt/wt %; and a buffer preferably natural buffer such as baking soda from 0.1 to 0.4 wt/wt %. In one embodiment the composition further comprises guar gum present in the amount from 0 to 1.2 wt/wt %.

In another aspect, the present invention relates to the composition described above, wherein the nut is an edible seed in the form of a paste or a powder wherein D[4,3] particle size of the creamer ranging from 5 to 16 microns. In one embodiment of the present invention, the edible nut comprises hazelnut, walnut, macadamia, almond, cashew, peanut, chestnut, pistachios, pecan and combinations thereof. In one embodiment, the creamer of the present composition further includes a pH buffer comprising sodium bicarbonate ranging from 0.1 to 0.4 wt/wt % of the creamer composition.

The creamers are easily dispersible in coffee, stable in hot and cold acidic environment, without feathering, breaking emulsion, de-oiling, flocculation, and/or sedimentation. When added to coffee or tea or other liquid products, the creamers provide improved mouthfeel, full body, smooth texture, and also a good flavor with no off-flavor notes developed during storage.

Advantageously and unexpectedly the creamers of the present invention is stable (physical and chemical) and has preferred texture/mouthfeel/smoothness, and pleasant taste when added in coffee. In addition, the creamers have a good physico-chemical stability during shelf life.

The ESL creamers are stable at refrigeration for at least 5 months.

Though the present invention discloses the coffee creamers, use of the creamers, it is not limited for only coffee applications. For example, the creamers can be also used for other beverages, such as tea or cocoa, or used with cereals or berries, creamers for soups, in many cooking applications.

The products of the invention present excellent organoleptic properties, in particular in terms of texture and mouthfeel even when very high levels of fat are used. Besides, the products of the invention show good stability and can therefore advantageously allow avoiding the use of non-natural additives.

Another aspect of the present invention relates to a process of preparing the creamer composition comprising:

dissolving the ingredients in hot water under agitation;

sterilizing the composition using ultra-high temperature (UHT) treatment;

homogenizing the composition at temperature ranging from 70-85° C.; wherein homogenization is performed prior to UHT treatment, post UHT treatment, or prior and post UHT treatment; and

cooling and filing the creamer under aseptic conditions.

### BRIEF DESCRIPTION OF THE FIGURES

FIG. 1 shows Instability Index of the products (A, B, C and D represents Examples 1, 2, 3 and 4 respectively).

### DETAILED DESCRIPTION OF THE INVENTION

In the following description, unless otherwise indicated % of a component means the % of weight based on the weight of the creamer composition, i.e. weight/weight %.

The invention pertains to nut containing beverage, more particularly to edible nut containing liquid creamers which stability, texture and mouthfeel are improved as a result of an optimized process of preparation including the controlled use of heat and acidic conditions.

In one embodiment of the present invention, the creamer further comprises of vegetable oils ranges from 0 to 8 wt/wt % of the creamer composition.

For the best mouthfeel, and physico-chemical properties as such and when added to hot coffee, the creamer composition comprises between about 2% and about 11% oil. Preferably, the unsaturated oil comprises a vegetable oil selected from the group consisting of high oleic canola, high oleic soybean oil, high oleic sunflower, high oleic safflower, coconut oil or a combination thereof.

In another embodiment of the present invention, the creamer comprises of sugar comprising sucrose, glucose, fructose, contained in cane sugar, beet sugar, molasses and/or combinations ranging from 0-35% of the creamer composition. Non-limiting examples of the sugar source include beets, canes, honey, molasses, agave syrup, maple syrup, malt, rice, oat, pea, corn, tapioca, potato sugar cane juice, yacon syrup or a combination thereof.

In another embodiment of the present invention, the creamer comprises a sweetener in an amount of 0 to about 10% by weight of the composition. By “sweetener” it is to be understood a mixture of ingredients which imparts sweetness to the final product. These include natural plant derived nutritive and non-nutritive sweeteners such as stevia or monk fruit.

In one embodiment of the present invention, the creamer comprises oil-in-water emulsion.

A beverage composition comprises the creamer as described in the present invention wherein the beverage is a coffee beverage, a cocoa or chocolate beverage, a malted beverage, and/or ready-to-drink beverage.

A beverage according to the invention comprises the creamer as described in the present invention and may e.g. be in the form of liquid or liquid concentrate to be mixed with a suitable liquid, e.g. water or milk, before consumption, or a ready-to-drink beverage. By a ready-to-drink beverage is meant a beverage in liquid form ready to be consumed without further addition of liquid.

In one embodiment, the creamers comprises natural flavors and/or colors.

The Lumisizer (LUM, Germany) Model 611 was used to evaluate the stability against creaming. Lumisizer (LUM, Germany) is an instrument using light scattering detection under sample centrifugation. It is especially designed to assess different separation phenomena based on oil droplet creaming or particle sedimentation occurring in oil-in-water emulsions and dispersions. In the Lumisizer, the so-called STEP technology (Step and Time resolved Extinction Profiles) is used. The samples were measured without dilution and centrifugal forces were exerted up to 2 hours at 20° C. and 2300 g force. The transmission profiles of samples were taken every 20 sec.

From the raw transmission profiles, the integral of transmission over time is calculated and its slope (named an Instability Index) was used as a quantitative measure for emulsion instability against creaming. Separation graphs shows movements of the interface between the dispersed phase, i.e. the movement of emulsion layers, and the clear phase, as a function of time.

The difference in separation rates (Instability Index) between the samples allowed to assess relative stability of emulsions against creaming. The integral transmission (T) was plotted as a function of time (t), and the slope (ΔT/Δt) was calculated. A higher slope (Instability Index) indicates a faster separation and thus a less stable product.

The size of particles, expressed in microns for volume mean diameter D[4,3] of the cumulative distribution measured using Malvern Mastersizer 3000 (laser diffraction unit). Ultra pure and gas free water was prepared using Honeywell water pressure reducer (maximum deionised water pressure: 1 bar) and ERMA water degasser (to reduce the dissolved air in the deionised water).

In one embodiment of the present invention, the mean D[4,3] particle size of the creamer ranges from 5 to 16 microns.

A ready-to-drink beverage of the present invention may be subjected to a heat treatment to increase the shelf life or the product, e.g. by retorting, UHT (Ultra High

Temperature) treatment, HTST (High Temperature Short Time) pasteurization, batch pasteurization, or hot fill.

### EXAMPLES

The present invention is illustrated further herein by the following non-limiting examples.

### Example 1

Liquid creamers were produced as below. A dry blend of sugar, sodium bicarbonate, high acyl gellan gum, acacia senegal gum, guar gum, sea salt, natural flavors was prepared by mixing together 22.5 kg of sucrose with 0.3 kg of sodium bicarbonate, 0.12 kg of high acyl gellan, 0.6 kg of acacia senegal gum, 0.1 kg of sea salt, 0.1 kg of natural flavors. The dry blend was added into 50 kg of hot water (˜75° C.) under high agitation.

Next, and after 5 minutes of mixing under continuous high agitation, 4.5 kg of almond paste were added into the tank under high agitation for 5 minutes.

Remain water was added to adjust the total amount to 100 kg.

The liquid creamer was pre-homogenized at 130/30 bars, pre-heated, UHT treated for 12 sec at 140° C., homogenized at 130/30 bars and cooled. The liquid creamer was aseptically filled into bottles. The resultant liquid creamer can be aseptically filled in any aseptic containers such as, for example, jars, jugs or pouches. The liquid creamer was stored 5 month at 4° C.

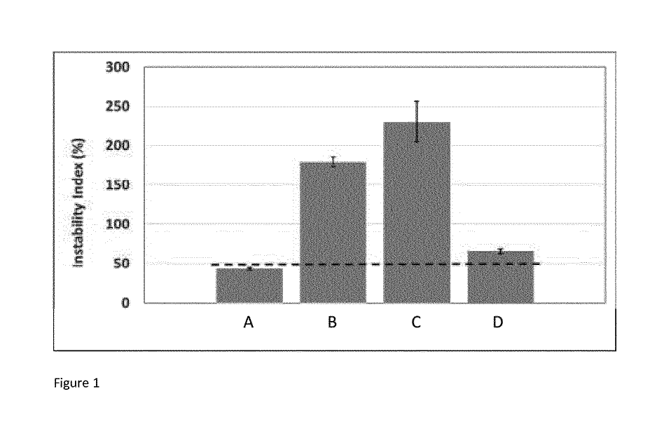

The physico-chemical stability and sensory of creamer and coffee beverages with added liquid creamer were judged by trained panellists. No phase separation (creaming, de-oiling, marbling, etc), gelation, and practically no viscosity changes were found during the storage. Further, the product has low Instability Index (FIG. 1, A).

It was surprisingly found that the liquid creamer has good appearance, mouth-feel, smooth texture and a good flavor without “off” taste. In addition, the creamer showed high whitening capacity when added to a coffee.

### Example 2

A liquid creamer was prepared as in Example 1 but using 100 g of high acyl gellan gum, 100 g of guar gum, and 600 g of Acacia Senegal gum. The physico-chemical stability and sensory of liquid creamer and coffee beverages with added liquid creamer were judged by trained panellists. After 1-months storage at 30° C., the sensory evaluation showed severe gelation in the bottle. Further, the product has very high Instability Index (FIG. 1, B).

### Example 3

A liquid creamer was prepared as in Example 1 but using 100 g of guar gum and 110 g of carrageenans. The physico-chemical stability and sensory of liquid creamer and coffee beverages with added liquid creamer were judged by trained panelists. After 1-month of storage at 4° C., the sensory evaluation showed unacceptable phase separation (syneresis, creaming) and gelation. Further, the product has very high Instability Index (FIG. 1, C).

### Example 4

A liquid creamer was prepared as in Example 1 but using 400 g of sunflower lecithin. The physico-chemical stability and sensory of liquid creamer and coffee beverages with added liquid creamer were judged by trained panelists. After 2-months storage at 4° C., the sensory evaluation showed unacceptable phase separation (syneresis, creaming). Further, the product has high Instability Index (FIG. 1, D).

### Example 5

A liquid creamer was prepared as in Example 1 but using 6 kg of almond paste. The physico-chemical stability and sensory of liquid creamer and coffee beverages with added liquid creamer were judged by trained panellists. After 2-months storage at 30° C., the sensory evaluation showed severe gelation in the bottle. No phase separation (creaming, de-oiling, marbling, etc), gelation, and practically no viscosity changes were found during the storage.

It was surprisingly found that the liquid creamer has good appearance, mouth-feel, smooth texture and a good flavor without “off” taste. In addition, the creamer showed high whitening capacity when added to a coffee. Further, the product has low Instability Index

### Example 6

A liquid creamer was prepared as in Example 1 but using 6 kg of almond paste, 100 g of high acyl gellan gum, 100 g of guar gum, and 600 g of Acacia Senegal gum. The physico-chemical stability and sensory of liquid creamer and coffee beverages with added liquid creamer were judged by trained panellists. After 2-months storage at 4° C., the sensory evaluation showed unacceptable phase separation (syneresis, creaming).

### Example 7

A liquid creamer was prepared as in Example 1 but using 4.5 kg of almond paste and 3 kg of coconut oil. The physico-chemical stability and sensory of liquid creamer and coffee beverages with added liquid creamer were judged by trained panelists. No phase separation (creaming, de-oiling, marbling, etc), gelation, and practically no viscosity changes were found during the storage.

It was surprisingly found that the liquid creamer has good appearance, mouth-feel, smooth texture and a good flavor without “off” taste. In addition, the creamer showed high whitening capacity when added to a coffee.

### Example 8

A liquid creamer was prepared as in Example 1 but using 4.5 g of almond paste, 3 k of coconut oil, 100 g of high acyl gellan gum, 100 g of guar gum, and 600 g of Acacia Senegal gum. The physico-chemical stability and sensory of liquid creamer and coffee beverages with added liquid creamer were judged by trained panelists. After 2-months storage at 20° C., the sensory evaluation showed unacceptable phase separation (syneresis, creaming).

### Example 9

A liquid creamer was prepared as in Example 1 but using 6 kg of almond paste and 3 kg of coconut oil. The physico-chemical stability and sensory of liquid creamer and coffee beverages with added liquid creamer were judged by trained panelists. No phase separation (creaming, de-oiling, marbling, etc), gelation, and practically no viscosity changes were found during the storage.

It was surprisingly found that the liquid creamer has good appearance, mouth-feel, smooth texture and a good flavor without “off” taste. In addition, the creamer showed high whitening capacity when added to a coffee.

### Example 10

A liquid creamer was prepared as in Example 1 but using 4.5 kg of almond paste, 3 kg of coconut oil, 100 g of high acyl gellan gum, 100 g of guar gum, and 600 g of Acacia Senegal gum. The physico-chemical stability and sensory of liquid creamer and coffee beverages with added liquid creamer were judged by trained panelists. After 2-months storage at 20° C., the sensory evaluation showed unacceptable phase separation (syneresis, creaming).

1. A liquid natural plant-based creamer composition comprising:
an edible nut;
high acyl gellan gum present in an amount ranging from 0.07 to 0.15 wt/wt %;
acacia senegal gum present in an amount ranging from 0.3 to 1.5 wt/wt %; and
buffer ranging from 0.1 to 0.4 wt/wt %.

2. The composition of claim 1, wherein the nut is an edible seed in the form of a paste or a powder.

3. The composition of claim 2, wherein the edible seed is selected from the group consisting of hazelnut, walnut, almond, cashew, peanut, chestnut, macademia, pistachios, pecan and combinations thereof.

4. The creamer of claim 1 wherein the composition further comprises vegetable oils ranging from 0 to 8 wt/wt % of the creamer composition.

5. The creamer of claim 4 wherein the vegetable oils comprises a vegetable oil selected from the group consisting of coconut oil, high oleic canola, high oleic soybean oil, high oleic sunflower, high oleic safflower and combinations thereof.

6. The creamer of claim 1, further comprises sugar selected from the group consisting of sucrose, glucose, fructose and/or combinations ranging from 0-35 wt/wt % of the creamer composition.

7. The creamer according to claim 1, comprising a natural sweetener in an amount of about 0 to about 10 by wt/wt % of the composition.

8. The creamer according to claim 1, includes a pH buffer comprising sodium bicarbonate ranging from 0.1 to 0.4 wt/wt % of the creamer composition.

9. The creamer according to claim 1, further includes guar gum present in the amount ranging from 0 to 0.12 wt/wt % of the creamer composition.

10. The creamer according to claim 1, wherein the mean D[4,3] particle size of the creamer ranges from 5 to 16 microns.

11. A beverage comprising water, a beverage-forming component and a sufficient amount of the creamer composition comprising an edible nut, high acyl gellan gum present in an amount ranging from 0.07 to 0.15 wt/wt % of the creamer, acacia senegal gum present in an amount ranging from 0.3 to 1.5 wt/wt % of the creamer, and buffer ranging from 0.1 to 0.4 wt/wt % of the creamer to provide whitening, good texture and mouthfeel.

12. The beverage of claim 11 wherein the beverage forming component is selected from the group consisting of coffee, tea, and chocolate.

13. A process of preparing a creamer composition comprising:
dissolving the ingredients in hot water under agitation;
sterilizing a resultant composition using ultra-high temperature (UHT) treatment;
homogenizing the composition at temperature ranging from 70-85° C. wherein homogenization performed before UHT treatment, after UHT treatment, or before and after UHT treatment; and
cooling and filing a resultant creamer composition comprising an edible nut, high acyl gellan gum present in an amount ranging from 0.07 to 0.15 wt/wt %, acacia senegal gum present in an amount ranging from 0.3 to 1.5 wt/wt %, and buffer ranging from 0.1 to 0.4 wt/wt % under aseptic conditions.
